(19) United States
(12) Patent Application Publication
(10) Pub. No.: US 2013/0027049 A1
(43) Pub. Date: Jan. 31, 2013

(54) Method for Determining Battery Pack Isolation Resistance Via Dual Bus Monitoring

(71) Applicant: Martin Sukup, San Francisco, CA (US)

(72) Inventor: Martin Sukup, San Francisco, CA (US)

(73) Assignee: Tesla Motors, Inc., Palo Alto, CA (US)

(21) Appl. No.: 13/192,537

(22) Filed: Jul. 28, 2011

(51) Int. Cl. G01N 27/416

(52) U.S. Cl. 324/430

(57) ABSTRACT

A method for measuring and calculating the isolation resistance of a battery pack is provided, the method being invulnerable to changes in the bus voltage that may take place between measurements.

### FIELD OF THE INVENTION

The present invention relates generally to battery pack safety and, more particularly, to a method for accurately determining the isolation characteristics of a battery pack during vehicle operation, charging and/or storage.

### BACKGROUND OF THE INVENTION

Electric vehicles, both those utilizing all-electric drive trains (i.e., EVs) and those utilizing multiple propulsion sources one of which is an electric drive system (i.e., hybrids), utilize high voltage batteries/battery packs as well as a variety of high voltage electronic and power system components. As a result of these high voltage and high power levels, it is imperative that the high voltage power system be electrically isolated, both in order to protect other vehicle components that are susceptible to high voltage damage as well as to insure the safety of vehicle passengers and others that may possibly come into contact with an electric vehicle's high voltage system (e.g., service technicians, crash site first responders, bystanders, etc.).

A variety of standards have been generated that are intended to insure that the high voltage system of an electric vehicle is sufficiently isolated from other vehicle structures. One such standard, SAE J1766, provides that the value for the electrical isolation of a high voltage battery pack that is not continuously monitored must be 500 Ohms/volt or greater. The method of calculating the electrical isolation in accordance with SAE J1766 will now be described relative to FIG. 1.

FIG. 1 provides a simplified representation of a high voltage system applicable to electric vehicles. As shown, battery pack 101 is coupled to a load 103, load 103 representing the high voltage motor and/or other high voltage components associated with an electric vehicle. In the conventional isolation measurement technique, the voltage V1 between the negative side of the high voltage bus and ground is measured as is the voltage V2 between the positive side of the high voltage bus and ground. If V1 is greater than V2, then it is given that the isolation resistance R_{ISON} on the negative side of the bus is greater than the isolation resistance R_{ISOP} on the positive side of the bus. Since the lower isolation resistance is of greater importance from a safety point of view, in the next step of the method a standard known resistance R_{STN} is inserted between the negative side of the high voltage bus and ground. Then V1′ is measured (see FIG. 2) and R_{ISOP} calculated from the equation:

R_{ISOP}=R_{STN}(1+V2/V1)((V1−V1′)/V1′)

Similarly, if V2 is greater than V1, then R_{ISON} is determined by inserting a standard known resistance R_{STP} between the positive side of the high voltage bus and ground. Next, V2′ is measured (see FIG. 3) and R_{ISON} calculated from the equation:

R_{ISON}=R_{STP}(1+V1/V2)((V2−V2′)/V2′)

In order to determine whether or not the isolation resistance is large enough to meet the applicable standard, the calculated isolation resistance, either R_{ISOP} if V1>V2 or R_{ISON} if V2>V1, is divided by the high voltage bus voltage, V_{BUS}, and compared to the minimum acceptable isolation resistance per volt as provided by the applicable standard.

While the standard approach of determining isolation resistance is adequate for many applications, it should be noted that this approach assumes that the bus voltage remain unchanged between measurements. If the bus voltage changes between measurements, an error may be introduced into the measurements. For example, assuming an initial bus voltage of 400 volts and a 5 megaohm resistance between each high voltage rail and ground, the graph of FIG. 4 shows that this error may be quite large, even for relatively small changes in bus voltage. Accordingly, what is needed is a method that is not susceptible to the introduction of errors due to a changing bus voltage. The present invention provides such a method.

### SUMMARY OF THE INVENTION

The present invention provides a method for measuring and calculating the isolation resistance of a battery pack, the method being invulnerable to changes in the bus voltage that may take place between measurements. The disclosed method is comprised of the steps of (a) measuring a first voltage VP0 between a positive bus of the battery pack and ground, (b) measuring a second voltage VN0 between a negative bus of the battery pack and ground, and (c) determining whether the VP0 is less than, or greater than, the VN0. If the measured VP0 is less than the measured VN0, the method further comprises the steps of (d) inserting a known resistance R_{STN} between the negative bus of the battery pack and ground, (e) measuring a third voltage VP1 between the positive bus of the battery pack and ground, (f) measuring a fourth voltage VN1 between the negative bus of the battery pack and ground, and (g) calculating the isolation resistance R_{ISO} of the battery pack where R_{ISO} is equal to [R_{STN}*(VP1/VN1−VP0/VN0)]. If the measured VP0 is greater than the measured VN0, the method further comprises the steps of (h) inserting a known resistance R_{STP} between the positive bus of the battery pack and ground, (i) measuring a fifth voltage VP2 between the positive bus of the battery pack and ground, (j) measuring a sixth voltage VN2 between the negative bus of the battery pack and ground, and (k) calculating the isolation resistance R_{ISO} of the battery pack where R_{ISO} is equal to [R_{STP}*(VN2/VP2−VN0/VP0)]. If the measured VP0 is equal to the measured VN0, then the method may further comprise either steps (d) through (g) or steps (h) through (k). Step (d) may further comprise the step of closing a switch SN, wherein closing switch SN inserts R_{STN} between the negative bus of the battery pack and ground. Step (h) may further comprise the step of closing a switch SP, wherein closing switch SP inserts R_{STP} between the positive bus of the battery pack and ground. The method may include the step of coupling the battery pack to the drive train of an electric vehicle, where the battery pack provides power for the drive train.

A further understanding of the nature and advantages of the present invention may be realized by reference to the remaining portions of the specification and the drawings.

### BRIEF DESCRIPTION OF THE DRAWINGS

FIG. 1 provides a simplified representation of a high voltage system applicable to electric vehicles;

FIG. 2 illustrates the high voltage system shown in FIG. 1, with the addition of a known resistance inserted between the negative high voltage bus and ground;

FIG. 3 illustrates the high voltage system shown in FIG. 1, with the addition of a known resistance inserted between the positive high voltage bus and ground;

FIG. 4 provides a graph that illustrates the error that can be introduced into the isolation resistance calculation when using the conventional method;

FIG. 5 illustrates an isolation measurement system applicable to the present invention;

FIG. 6 illustrates the isolation measurement system of FIG. 5 with the switch on the negative bus closed;

FIG. 7 illustrates the isolation measurement system of FIG. 5 with the switch on the positive bus closed; and

FIG. 8 illustrates the preferred methodology in accordance with the invention.

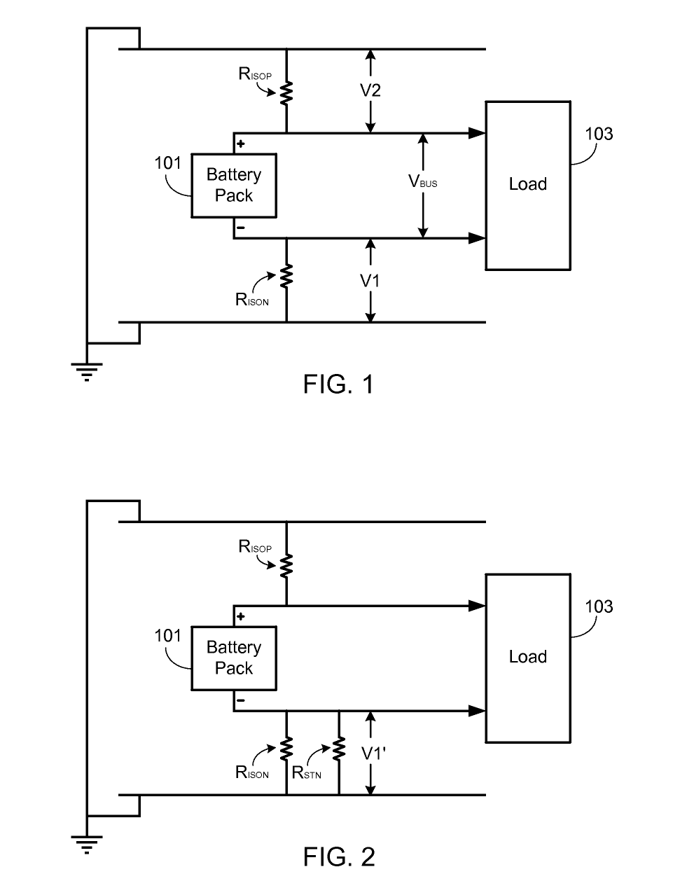

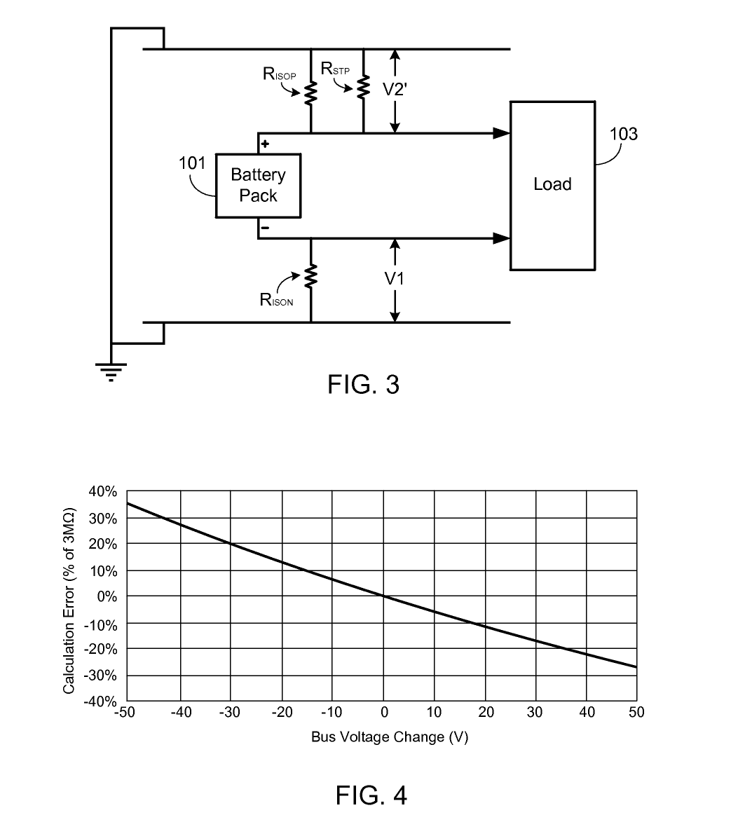

### DESCRIPTION OF THE SPECIFIC EMBODIMENTS

In the following text, the terms “battery”, “cell”, and “battery cell” may be used interchangeably and may refer to any of a variety of different cell types, chemistries and configurations including, but not limited to, lithium ion (e.g., lithium iron phosphate, lithium cobalt oxide, other lithium metal oxides, etc.), lithium ion polymer, nickel metal hydride, nickel cadmium, nickel hydrogen, nickel zinc, silver zinc, or other battery type/configuration. The term “battery pack” as used herein refers to multiple individual batteries contained within a single piece or multi-piece housing, the individual batteries electrically interconnected to achieve the desired voltage and capacity for a particular application. The term “electric vehicle” as used herein refers to either an all-electric vehicle, also referred to as an EV, plug-in hybrid vehicles, also referred to as a PHEV, or a hybrid vehicle (HEV), a hybrid vehicle utilizing multiple propulsion sources one of which is an electric drive system. It should be understood that identical element symbols used on multiple figures refer to the same component, or components of equal functionality. Additionally, the accompanying figures are only meant to illustrate, not limit, the scope of the invention and should not be considered to be to scale.

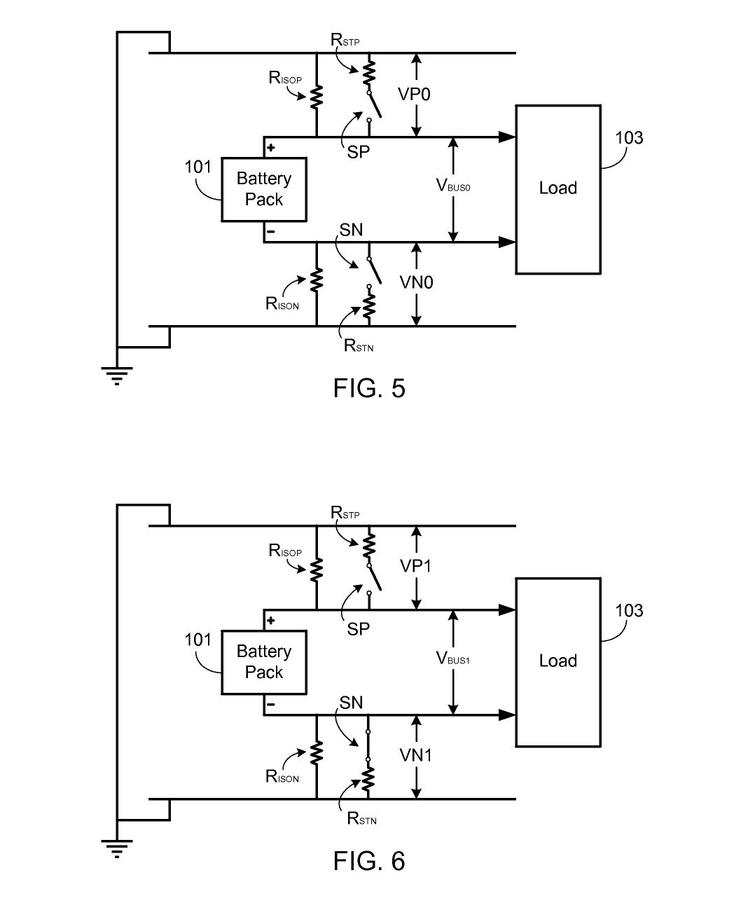

FIG. 5 illustrates a simplified representation of a high voltage system that includes means for switching a standard known resistance between ground and either the high voltage positive bus or the high voltage negative bus. As shown, a switch SP is used to insert a known resistance R_{STP} between the positive bus and ground. Similarly, a switch SN is used to insert a known resistance R_{STN} between the negative bus and ground.

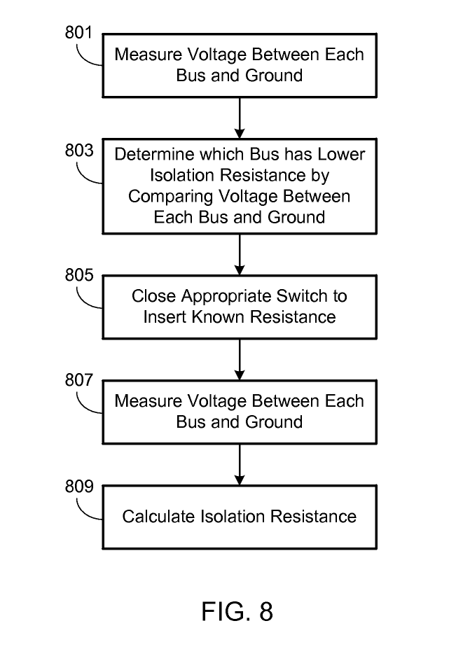

The first step of the method (step 801 of FIG. 8) is to measure the voltage VP0 between the positive bus and ground, and to measure the voltage VN0 between the negative bus and ground. Preferably VP0 and VN0 are measured at the same time. These voltages are measured with SP and SN open as shown in FIG. 5. These two voltages can be represented as:

VP0=V_{BUSO}*[R_{ISOP}/(R_{ISOP}+R_{ISON})]; [1]

VN0=V_{BUSO}*[R_{ISON}/(R_{ISOP}+R_{ISON})]; [2]

Dividing equation [1] by equation [2] yields:

VP0/VN0=R_{ISOP}/R_{ISON}; [3]

Solving equation [3] for R_{ISOP} yields:

R_{ISOP}=R_{ISON}*(VP0/VN0); [4]

Similarly, solving equation [3] for R_{ISON} yields:

R_{ISON}=R_{ISOP}*(VN0/VP0); [5]

In step 803, the voltages measured for the positive and negative buses (step 801) are compared in order to determine which bus has the lower isolation resistance since it is the lower isolation resistance that is of greater importance from a safety point of view. For clarity, a description of the methodology based on a lower isolation resistance on the positive bus as well as a description of the methodology based on a lower isolation resistance on the negative bus will be described.

From equation [3], if in step 803 it is determined that VP0 is less than VN0, then it is given that R_{ISOP} is less than R_{ISON}. As such, in this case R_{ISOP} is the isolation resistance of interest. To determine R_{ISOP}, switch SN is closed as illustrated in FIG. 6 (step 805), thereby introducing a known resistance R_{STN} between the negative high voltage bus and ground. Next, the voltage VP1 between the positive bus and ground, and the voltage VN1 between the negative bus and ground are each measured (step 807). Preferably VP1 and VN1 are measured simultaneously. The values for VP1 and VN1 can be described by:

$$\begin{matrix}VP 1 = {V}_{BUS 1} * [ \frac{{R}_{ISOP}}{{R}_{ISOP} + ( \frac{{R}_{ISON} * {R}_{STN}}{{R}_{ISON} + {R}_{STN}} )} ] ; & [ 6 ] \\ VN 1 = {V}_{BUS 1} * [ \frac{( \frac{{R}_{ISON} * {R}_{STN}}{{R}_{ISON} + {R}_{STN}} )}{{R}_{ISOP} + ( \frac{{R}_{ISON} * {R}_{STN}}{{R}_{ISON} + {R}_{STN}} )} ] ; & [ 7 ]\end{matrix}$$

Dividing equation [6] by equation [7] yields:

$$VP 1 / VN 1 = \frac{{R}_{ISOP}}{( \frac{{R}_{ISON} * {R}_{STN}}{{R}_{ISON} + {R}_{STN}} )} ; \qquad [ 8 ]$$

Substituting equation [5] into equation [8] yields (step 809):

R_{ISOP}=R_{STN}*(VP1/VN1−VP0/VN0); [9]

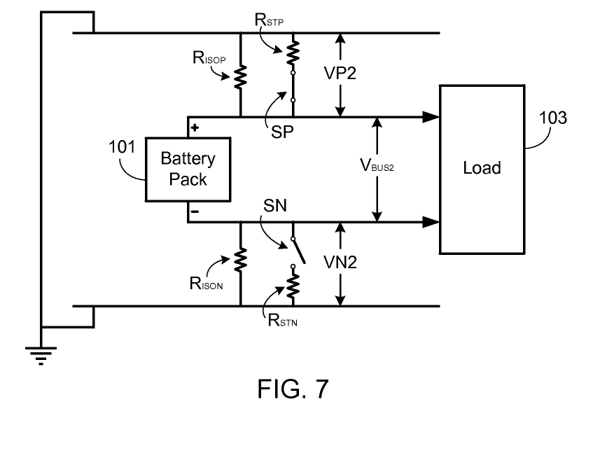

Similarly, if in step 803 it is determined that VN0 is less than VP0, then R_{ISON} is less than R_{ISOP} and the isolation resistance of the negative bus, R_{ISON}, is the isolation resistance of interest. To determine R_{ISON}, switch SP is closed rather than switch SN as illustrated in FIG. 7 (step 805), thereby introducing a known resistance R_{STP} between the positive high voltage bus and ground. Next, the voltage VP2 between the positive bus and ground, and the voltage VN2 between the negative bus and ground are each measured (step 807). Preferably VP2 and VN2 are measured simultaneously. The values for VP2 and VN2 can be described by:

$$\begin{matrix}VP 2 = {V}_{BUS 2} * [ \frac{( \frac{{R}_{ISOP} * {R}_{STP}}{{R}_{ISOP} + {R}_{STP}} )}{{R}_{ISON} + ( \frac{{R}_{ISOP} * {R}_{STP}}{{R}_{ISOP} + {R}_{STP}} )} ] ; & [ 10 ] \\ VN 2 = {V}_{BUS 2} * [ \frac{{R}_{ISON}}{{R}_{ISON} + ( \frac{{R}_{ISOP} * {R}_{STP}}{{R}_{ISOP} + {R}_{STP}} )} ] ; & [ 11 ]\end{matrix}$$

Dividing equation [10] by equation [11] yields:

$$VP 2 / VN 2 = \frac{( \frac{{R}_{ISOP} * {R}_{STP}}{{R}_{ISOP} + {R}_{STP}} )}{{R}_{ISON}} ; \qquad [ 12 ]$$

Substituting equation [4] into equation [12] yields (step 809):

R_{ISON}=R_{STP}*(VN2/VP2−VN0/VP0); [13]

It will be appreciated that in step 803 if it is determined that VN0 is equal to VP0, then the isolation resistance for the positive high voltage will be equivalent to the negative high voltage and the isolation resistance may be calculated using either equation [9] or equation [13].

Using this method, the isolation resistance of the battery pack may be repeatedly determined, preferably with sufficient frequency to detect battery pack isolation issues before an injury or property damage may occur.

As will be understood by those familiar with the art, the present invention may be embodied in other specific forms without departing from the spirit or essential characteristics thereof. Accordingly, the disclosures and descriptions herein are intended to be illustrative, but not limiting, of the scope of the invention which is set forth in the following claims.

What is claimed is:

1. A method of calculating an isolation resistance R_{ISO} for a battery pack, the method comprising the steps of:
(a) measuring a first voltage VP0 between a positive bus of said battery pack and ground;
(b) measuring a second voltage VN0 between a negative bus of said battery pack and ground;
(c) determining whether said VP0 is less than, or greater than, said VN0, wherein if said VP0 is less than said VN0, the method further comprises the steps of:
(d) inserting a known resistance R_{STN} between said negative bus of said battery pack and ground;
(e) measuring a third voltage VP1 between said positive bus of said battery pack and ground;
(f) measuring a fourth voltage VN1 between said negative bus of said battery pack and ground; and
(g) calculating said R_{ISO} from the equation R_{ISO}=[R_{STN}*(VP1/VN1−VP0/VN0)]; and wherein if said VP0 is greater than said VN0, the method further comprises the steps of:
(h) inserting a known resistance R_{STP} between said positive bus of said battery pack and ground;
(i) measuring a fifth voltage VP2 between said positive bus of said battery pack and ground;
(j) measuring a sixth voltage VN2 between said negative bus of said battery pack and ground; and
(k) calculating said R_{ISO}, from the equation R_{ISO}=[R_{STP}*(VN2/VP2−VN0/VP0)].

2. The method of claim 1, wherein steps (a) through (k) are performed repeatedly.

3. The method of claim 1, wherein if said VP0 is equal to said VN0 in step (c), then steps (d) through (g) are performed.

4. The method of claim 1, wherein if said VP0 is equal to said VN0 in step (c), then steps (h) through (k) are performed.

5. The method of claim 1, wherein step (d) further comprises the step of closing a switch SN, wherein closing said switch SN inserts R_{STN} between said negative bus of said battery pack and ground.

6. The method of claim 1, wherein step (h) further comprises the step of closing a switch SP, wherein closing said switch SP inserts R_{STP} between said positive bus of said battery pack and ground.

7. The method of claim 1, wherein steps (a) and (b) are performed simultaneously.

8. The method of claim 1, wherein steps (e) and (f) are performed simultaneously.

9. The method of claim 1, wherein steps (i) and (j) are performed simultaneously.

10. The method of claim 1, further comprising the step of coupling said battery pack to a drive train of an electric vehicle, wherein said battery pack provides power for said drive train.
